(19) United States
(12) Patent Application Publication
(10) Pub. No.: US 2024/0289052 A1
(43) Pub. Date: Aug. 29, 2024

(54) ORDERING ENTRIES OF AN INPUT COMMAND QUEUE

(71) Applicant: Micron Technology, Inc., Boise, ID (US)

(72) Inventors: Jonathan S. Parry, Boise, ID (US); David Aaron Palmer, Boise, ID (US); Reshmi Basu, Boise, ID (US)

(21) Appl. No.: 18/442,936

(22) Filed: Feb. 15, 2024

Related U.S. Application Data
(60) Provisional application No. 63/447,823, filed on Feb. 23, 2023.

(51) Int. Cl. G06F 3/06

(52) U.S. Cl. CPC G06F 3/0659; G06F 3/0613; G06F 3/0683

(57) ABSTRACT

Methods, systems, and devices for ordering entries of an input command queue are described. A memory system may include an interface (e.g., a host interface) that includes a queue (e.g., an input command queue). The host interface may receive commands from a host system, and the commands may be inserted into the input command queue in an order they are received. In some examples, the memory system may determine a range of logical block addresses (LBAs) associated with one or more entries in the input command queue. The memory system may order (e.g., reorder) the commands such that the respective LBA ranges are contiguous.

### CROSS REFERENCE

The present Application for Patent claims priority to and the benefit of U.S. Provisional Application No. 63/447,823 by Parry et al., entitled “ORDERING ENTRIES OF AN INPUT COMMAND QUEUE,” filed Feb. 23, 2023, assigned to the assignee hereof, and is expressly incorporated by reference in its entirety herein.

### TECHNICAL FIELD

The following relates to one or more systems for memory, including ordering entries of an input command queue.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports ordering entries of an input command queue in accordance with examples as disclosed herein.

FIG. 2 illustrates an example of a system that supports ordering entries of an input command queue in accordance with examples as disclosed herein.

FIG. 3 illustrates an example of a process flow that supports ordering entries of an input command queue in accordance with examples as disclosed herein.

FIG. 4 illustrates a block diagram of a memory system that supports ordering entries of an input command queue in accordance with examples as disclosed herein.

FIG. 5 illustrates a flowchart showing a method or methods that support ordering entries of an input command queue in accordance with examples as disclosed herein.

### DETAILED DESCRIPTION

Some memory systems may include one or more queues for receiving commands from a host system. For example, a memory system may include a host interface (HIF) that includes a queue (e.g., an input command queue) for receiving commands from the host systems. The commands received from the host system may include a starting logical block address (LBA) and a length. The commands may be ordered in the input command queue in an order they are received and thus some sequential commands may be associated with non-contiguous LBAs.

Traditional memory systems may not have time or processing resources to search (e.g., scan) the input command queue to order commands associated with contiguous LBAs together. Instead the memory system may process the commands sequentially, which may result a greater quantity of operations being performed, operations being performed on various regions of the memory system in parallel, or both. Reordering the commands in a memory system controller as it executes the commands may be inefficient because the controller may need to query the input command queue to determine the commands and associated LBAs, and may have initiated allocation of physical addresses prior to determining the reordering, which may lead to inefficient reallocation of physical addresses.

A memory system configured to order entries in an input command queue is described herein. For example, the memory system described herein may be configured to receive one or more commands at an input command queue of a HIF. Each command may be associated with a starting LBA and a length. The commands may initially be ordered in the order they are received from the host system. The memory system may be configured to determine the range of LBAs of one or more commands in the input command queue and may order (e.g., reorder) the commands such that the respective LBA ranges are contiguous. Accordingly, the commands may be processed more efficiently, which may improve the overall performance of the memory system.

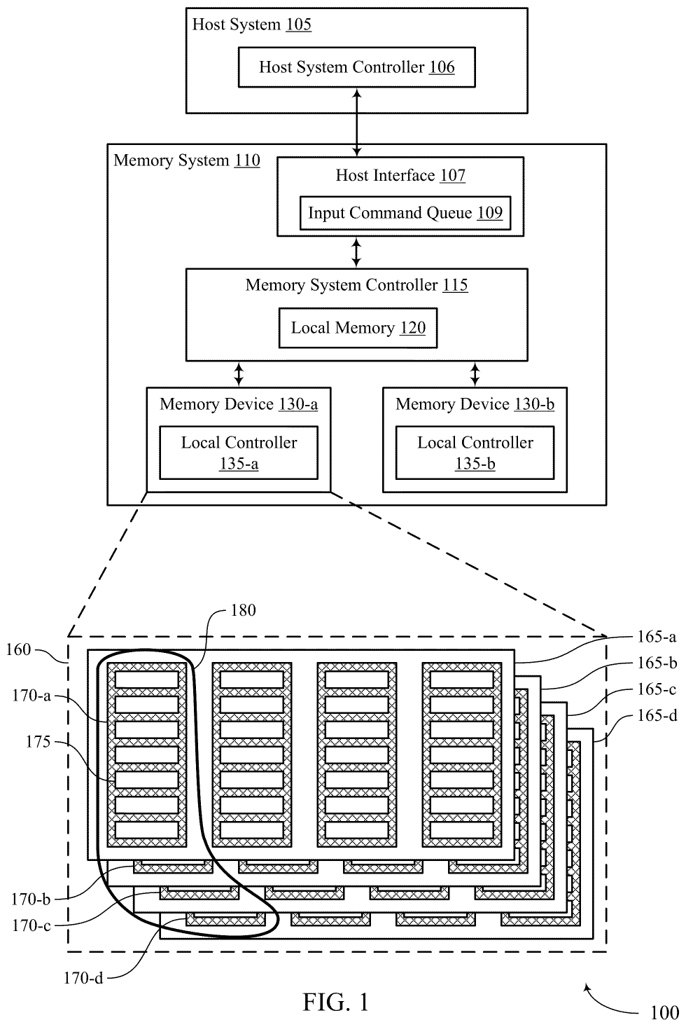

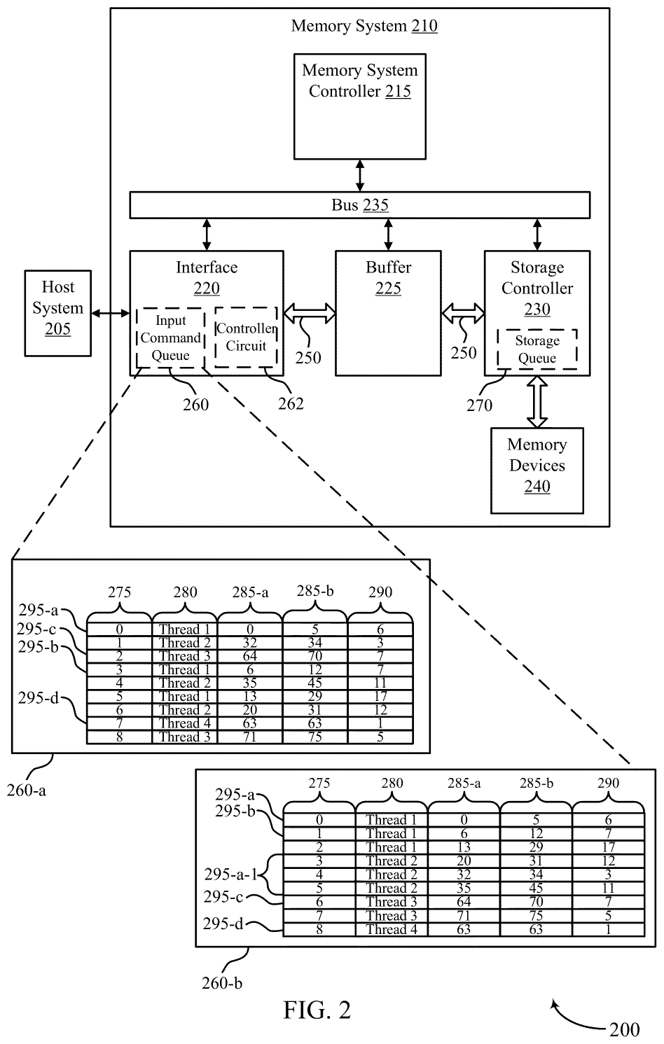

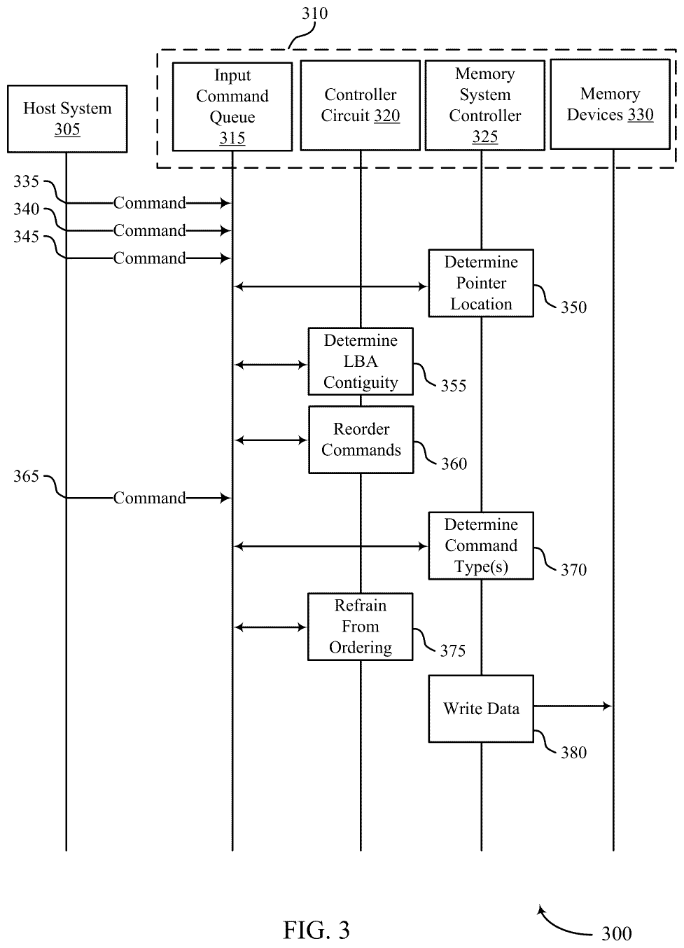

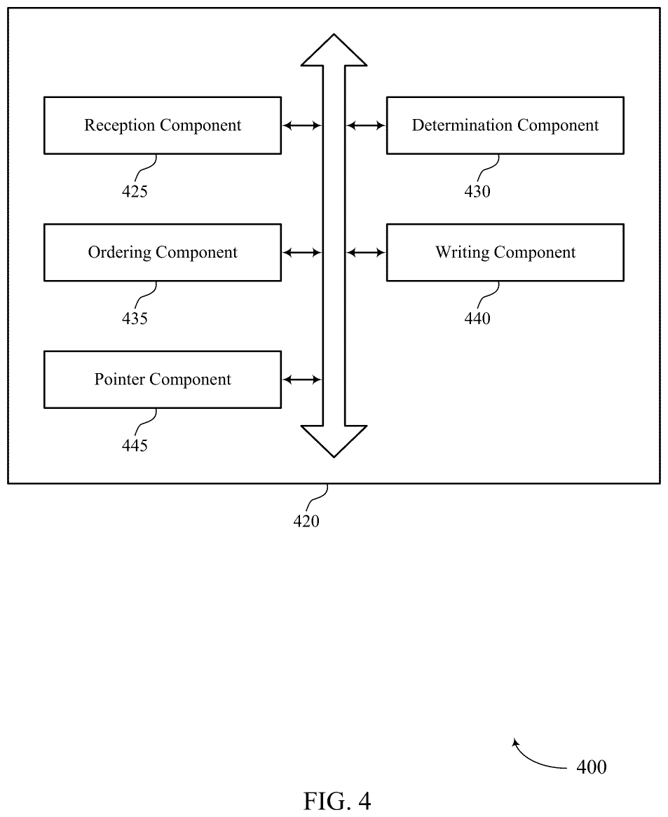

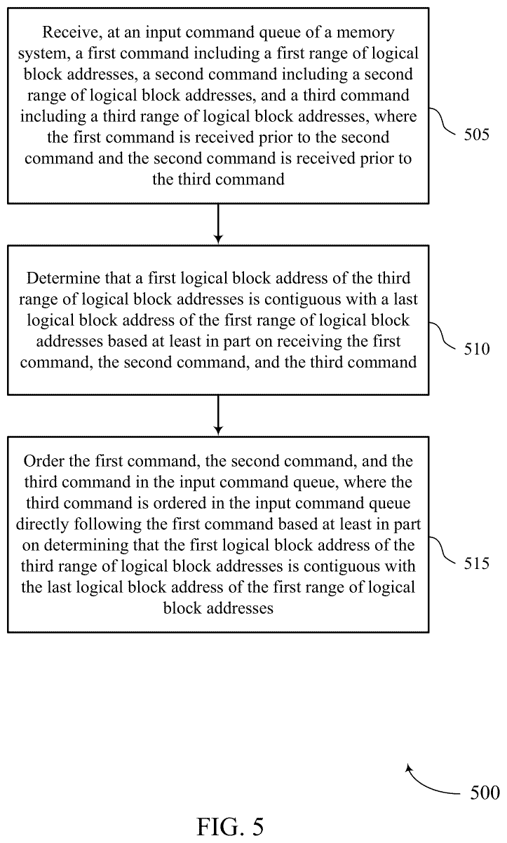

Features of the disclosure are initially described in the context of a system with reference to FIGS. 1 and 2. Features of the disclosure are described in the context of a process flow with reference to FIG. 3. These and other features of the disclosure are further illustrated by and described in the context of an apparatus diagram and flowchart that relate to ordering entries of an input command queue with reference to FIGS. 4 and 5.

FIG. 1 illustrates an example of a system 100 that supports ordering entries of an input command queue in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support ordering entries of an input command queue. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

The memory system 110 may include a HIF 107 that includes an input command queue 109. In some instances, the HIF 107 may receive commands from the host system 105 and the commands may be added to the input command queue 109. Each command may be associated with a starting LBA and a length. The commands may initially be ordered in the order they are received from the host system 105. The HIF may include a controller or processor (not shown) configured to determine the range of LBAs of one or more commands in the input command queue 109 and may order (e.g., reorder) the commands such that the respective LBA ranges are contiguous. Accordingly, the commands may be processed more efficiently, which may improve the overall performance of the memory system 110.

FIG. 2 illustrates an example of a system 200 that supports ordering entries of an input command queue in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively. In some instances, the system 200 may order (e.g., reorder) commands in the input command queue 260 such that the LBA ranges of the respective commands are contiguous. Accordingly, the commands may be processed more efficiently, which may improve the overall performance of the system 200.

The memory system 210 may include an interface 220 (e.g., a HIF) for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components. In some instances, the interface 220 may include an input command queue 260 that receives commands (e.g., read commands, write commands) from the host system 205. As described, commands may be ordered within the interface 220 (e.g., by the controller circuit 262) to improve the overall performance of the memory system 210.

The memory system controller 215 may process received commands from the host system 205 according to an order (e.g., a first-in-first-out order, according to the order of the input command queue 260, a sorted list according to contiguous LBA addresses). The memory system controller 215 may be coupled with the interface 220, buffer 225, or storage controller 230 via bus 235. For example, bus 235 may be used to pass commands from the input command queue 260 to the memory system controller 215 and to pass commands used for transferring data between the buffer 225 and the memory devices 240 from the memory system controller 215 to the storage queue 270 for execution by the storage controller 230. To improve device performance and efficiency, commands within the input command queue 260 may be sorted by the controller circuit 262 as depicted in FIG. 2. The controller circuit 262 may be a dedicated circuit for handling (e.g., parsing, sorting) commands stored to the input command queue 260 and may be referred to, generically, as a controller. For example, the input command queue 260 may receive commands from the host system 205, and the commands may be stored in the input command queue 260 according to the order they are received.

The memory system controller 215 may process the commands according to their order in the input command queue 260. For example, each command may include an indication of a location within the buffer 225 that associated data is located. The memory system controller 215 may transmit the commands along a data path according to the order the commands are received from the host system 205. However, processing commands in such a manner may lead to system 200 inefficiency when commands with contiguous LBA addresses are present in the queue. Sorting commands within the input command queue 260 prior to the commands being processed (e.g., transmitted along a data path to other components of the memory system 210) may allow the memory system controller 215 to consolidate individually received commands into larger command groups or sequences, which may improve the overall performance of the system 200.

As an illustrative example, the input command queue 260-a illustrates a table of commands 295, including commands 295-a through 295-d. Column 275 depicts an indicator of the queue depth (QD), which may represent an initial sequential order the commands 295 are received in. Column 280 identifies the thread of operations the command 295 is part of (e.g., command 295-a is associated with Thread 1, command 295-d is associated with Thread 4). The threads identified in column 280 may be associated with different types of operations (e.g., read, write operations) performed by the host system 205, or different host system 205 applications or processes a given command is associated with.

For example, Thread 1 may be associated with a write operation for a first application, thus command 295-a may be a portion of a write command. Column 285-a may indicate a starting LBA associated with a command 295, and column 285-b may indicate an ending LBA associated with a command 295. Together, columns 285-a and 285-b may indicate a complete LBA range associated with a command 295. For example, column 285-a indicates that the starting LBA for command 295-a is 0, and column 285-b indicates the ending LBA for command 295-a is 5, thus indicating an LBA range of 0-5. Column 290 may indicate the length of the LBA range. Column 290 thus indicates a range of 6 associated with command 295-a for LBA addresses 0-5.

In the input command queue 260-a, the column 275 may illustrate that the commands 295 are ordered in the queue according to the order they were received from the host system 205. Columns 285-a and 285-b may illustrate that some LBA ranges associated with commands 295 are contiguous with one another. For example, command 295-a has an LBA range of 0-5, and command 295-b has an associated LBA range of 6-12, thus command 295-a and 295-b may contiguous commands (e.g., commands associated with contiguous LBAs).

The memory controller circuit 262 may parse the input command queue 260 to determine whether any commands 295 within the command queue have contiguous LBA addresses, and may reorder the commands within the input command queue 260. Reordering one or more commands such that the respective LBA ranges are contiguous may allow for the system 200 to access (e.g., read from, write to) the associated LBAs in fewer commands or in an otherwise more efficient manner. Accordingly, the input command queue 260-b illustrates a table of commands within input command queue 260 after the controller circuit 262 determines that some commands 295 have contiguous LBA addresses, and reorders contiguous commands within the input command queue 260.

The input command queue 260-b illustrates that commands 295-a and 295-b have been reordered by the controller circuit 262. In some examples, the associated QDs of each command may be updated based on the reordering. The input command queue 260-b further illustrates that additional commands 295 with contiguous LBA ranges have been reordered by the controller circuit 262.

In some additional or alternative examples, some commands with contiguous LBA addresses may not be reordered within the input command queue 260 by the controller circuit 262. That is, commands 295 that are associated with different operations or different types of operations may not be reordered. Thus, a command with a starting LBA that is contiguous with the ending LBA of another command in the queue may be identified by the controller circuit 262 (or the memory system controller 215), and one command may be a read command and the other may be a write command. Such commands may not be reordered.

For example, in the input command queue 260-a, columns 285-a and 285-b may illustrate that the ending LBA associated with command 295-d is contiguous with the starting LBA of command 295-c. However, column 280 indicates that command 295-c is associated with Thread 3, whereas command 295-d is associated with Thread 4. As shown in the input command queue 260-b, command 295-d may not be reordered to precede command 295-c. Accordingly, commands 295 that are associated with contiguous LBA addresses and a same type of operation (e.g., a read operation), may be reordered by the controller circuit 262.

For example, as illustrated in the input command queue 260-b, although command 295-d may be associated with an LBA range that is contiguous with command 295-c, the two commands may be associated with different types of operations, and thus may not be reordered. Thus, command 295-d may remain in the input command queue 260 while the controller circuit 262 reorders other commands 295 within the input command queue 260. If the threshold metric is satisfied for command 295-d, the memory system controller 215 may process command 295-d and remove it from input command queue 260.

Further, although command 295-d may not have been reordered by the memory system controller based on its associated LBA range, command 295-d may be located in a different position in the queue as shown in the input command queue 260-b. The command 295-d may be located in a different position in the queue due to other commands 295 being reordered (e.g., before the command 295-d).

Additionally, or alternatively, the memory system controller 215 may maintain a pointer for tracking which command 295 (or commands 295) are being processed. For example, a pointer may indicate (e.g., point) to a command 295 that is being processed. Thus, subsequently received commands may be ordered according to the ending LBA of the command 295 being processed. For example, if a command 295 being processed is associated with ending LBA 10, a subsequently received command 295 having a starting LBA 2 may not be reordered, whereas a subsequently received command 295 having a starting LBA 11 may be reordered to be contiguous with ending LBA 10.

Additionally or alternatively, the memory system controller 215 may process commands stored to the controller circuit 262. For example, the memory system controller 215 may determine one or more physical block addresses of the memory devices 240 to read data from or write data to. The physical block addresses may be determined (e.g., using an L2P table) based on the range of LBAs associated with a given command stored to the input command queue 260. In some instances, when the memory system controller 215 processes a command (or commands) stored to the input command queue 260, the memory system controller may indicate the completion of the command and the command may be removed from the input command queue 260.

In some additional or alternative examples, a command 295 may be received from the host system 205, and may be associated with a LBA range that is not contiguous with any other commands in the input command queue 260. The command 295 may remain in the queue until processed by the memory system controller 215 after a threshold is satisfied. For example, the command 295 may remain in the input command queue 260 until it is processed. In some instances, a delay may occur before processing the command (e.g., due to other commands being reordered), thus the command may remain in the input command queue 260 until a threshold time has been satisfied, until a threshold quantity of commands have been executed, or until another threshold is satisfied.

In some additional or alternative examples, upon ordering commands 295 with contiguous LBA ranges, the memory system controller 215 may compress the commands into fewer commands (or a single command) As an illustrative example, the memory system controller 215 may process commands 295 within command group 295-a-1, which includes three commands with contiguous LBA ranges, all associated with the same operation type (e.g., a read command). Upon processing the commands of the command group 295-a-1, the memory system controller 215 may execute a single command to read the associated data (e.g., as opposed to executing three separate commands) based on the data having been previously stored to contiguous physical addresses. In other examples, if command group 295-a-1 contained three commands 295 with contiguous LBA addresses, each including data associated with a portion of a write command, the memory system controller 215 may execute a single write command to write associated data to the rage of LBAs.

In some additional or alternative examples, the memory system controller may write data associated with commands with contiguous LBA ranges to contiguous physical block addresses within the memory system. For example, where command group 295-a-1 contains commands 295 with contiguous LBA ranges associated with a write operation, the memory system controller 215 may write the data associated with command group 295-a-1 to a contiguous range of physical addresses. The mapping of each logical-to-physical address as assigned by the memory system controller 215 may be stored to a separate component of the memory system 210 (e.g., to the memory devices 240 or to the buffer 225). By ordering (e.g., reordering) commands as described herein, the commands may be processed more efficiently, which may improve the overall performance of the memory system 210.

FIG. 3 illustrates an example of a process flow 300 that supports ordering entries of an input command queue in accordance with examples as disclosed herein. The process flow describes an example of an order of operations for sorting and executing commands as described with reference to FIGS. 1 and 2.

In some cases, process flow 300 may be implemented by aspects of the systems 100 and 200. For example, the process flow 300 may include operations performed by a host system 305 (e.g., a host system 205) and a memory system 310 (e.g., a memory system 210) that includes an input command queue 315, a controller circuit 320, a memory system controller 325, and one or more memory devices 330, which may be examples of the corresponding components described in FIGS. 1 and 2. In some instances, the memory system 310 may include an interface (e.g., a HIF) that includes the input command queue 315 and the controller circuit 320. In the following description of the process flow 300, the operations may be performed in a different order than the order shown. For example, specific operations may also be left out of the process flow 300, or other operations may be added to process flow 300.

The process flow 300 may illustrate an example of the controller circuit 320 ordering commands stored to the input command queue 315. For example, the controller circuit 320 may order (e.g., reorder) one or more commands such that the LBAs associated with the ordered (e.g., reordered) commands are contiguous. By ordering (e.g., reordering) commands as described herein, the commands may be processed more efficiently, which may improve the overall performance of the memory system 310.

Aspects of the process flow 300 may be implemented by a controller circuit 320, among other components. Additionally, or alternatively, aspects of the process flow 300 may be implemented as instructions stored in memory (e.g., firmware stored in a memory coupled with a host system or a memory system). For example, the instructions, when executed by a controller (e.g., the controller circuit 320, the memory system controller 325, or both), may cause the controller to perform the operations of the process flow 300.

At 335, the host system 305 may transmit a first command to the memory system 310. The first command may be associated with a first range of LBAs and may be received by the input command queue 315 of the memory system 310. In some examples, one or more commands may have been previously received and stored to the input command queue 315 (not shown).

At 340, the host system 305 may transmit a second command to the memory system 310. The second command may be associated with a second range of LBAs and may be received by the input command queue 315 of the memory system 310. The second command may be received after the first command (e.g., at 335). In some examples, a first LBA of the second command may be noncontiguous with a last LBA of the first command

At 345, the host system 305 may transmit a third command to the memory system 310. The third command may be associated with a third range of LBAs and may be received by the input command queue 315 of the memory system 310. The third command may be received after the second command (e.g., at 340). In some examples, a first LBA of the third command may be noncontiguous with a last LBA of the second command

In some examples (not shown), the host system 305 may have transmitted a fourth command, a fifth command, and a sixth command to the memory system 310 prior to transmitting the first command. The fourth, fifth, and sixth commands may be associated with respective ranges of LBAs and may be received by the input command queue 315 of the memory system 310.

At 350, the controller circuit 320 may determine a location of a pointer associated with the input command queue 315. As described herein, the pointer may indicate a specific command (or commands) that are currently being processed (e.g., by the memory system controller 325). Accordingly, the controller circuit 320 may only be able to order (e.g., reorder) commands received subsequent to the pointer. For example, the pointer may indicate that the sixth command is being processed, thus the controller circuit 320 may only be able to order (e.g., reorder) the first, second, and third commands. That is, the controller circuit 320 may refrain from ordering (e.g., reordering) the fourth command and the fifth command due to the commands being received prior to the sixth command.

At 355, the controller circuit 320 may determine the order of the first, second, and third LBA ranges of the respective commands stored to the input command queue 315. For example, the controller circuit 320 may determine that the commands were stored in the order received (e.g., first command, second command, third command), but the respective LBA ranges are noncontiguous. At 355, the controller circuit 320 may determine a contiguous order of the LBA ranges.

For example, the controller circuit 320 may determine that a first LBA of the second and third commands occurs (e.g., sequentially) after the last LBA of the first command. The controller circuit 320 may also determine that a first LBA of the third command is contiguous with the last LBA of the first command. Additionally, or alternatively, the controller circuit 320 may determine that a first LBA of the second command is contiguous with a last LBA of the third command.

At 360, the controller circuit 320 may reorder the commands stored to the input command queue 315. For example, the controller circuit 320 may reorder the commands based on the location of the pointer and the determination made at 355. By way of example, the controller circuit 320 may reorder the commands such that the third command directly follows the first command and such that the second command directly follows the third command. In other examples, the controller circuit 320 may reorder additional commands in the input command queue 315 such that the LBAs of the resulting commands are contiguous.

At 365, the host system 305 may transmit a seventh command to the memory system 310. The seventh command may be associated with a seventh range of LBAs and may be received by the input command queue 315 of the memory system 310. In some examples, the seventh command may be a different command type than the first, second, and third commands. For example, the seventh command may be a write commands and the first, second, and third commands may have been read commands (or vice versa).

At 370, the controller circuit 320 may determine a command type of the seventh command. The controller circuit 320 may also determine a command type of the prior commands in the input command queue 315. For example, the controller circuit 320 may determine that the seventh command is a different type of command than at least the first, second, and third commands. In other examples, the operations performed at 370 may be performed by the memory system controller 325.

At 375, the controller circuit 320 may refrain from reordering the seventh command based on the seventh command being a different type of command than at least the first, second, and third commands. Accordingly, the LBAs associated with the seventh command may be noncontiguous with other LBAs of commands included in the input command queue 315.

At 380, the memory system controller 325 may write data associated with the first, second, and third commands to one or more memory devices 330 of the memory system 310. For example, the memory system controller 325 may write first data associated with the first command, second data associated with the third command, and third data associated with the second command to a contiguous range of physical block addresses. The memory system controller 325 may receive the commands from the input command queue 315 and the pointer may be updated accordingly. In some examples, the memory system controller 325 may request the command(s) from the input command queue 315 or the command(s) may be pushed to the memory system controller 325.

In some instances, due to the LBAs being contiguous in the input command queue 315, the memory system controller 325 may be able to write the data using a single command (or a reduced quantity of commands) as opposed to executing three separate commands to write the respective data. That is, the memory system controller 325 may combine the commands and may determine one or more physical block addresses associated with the LBAs. The memory system controller 325 may also generate the command(s) to write the associated data to the one or more memory devices 330. The command(s) may be stored to a queue (e.g., a storage queue 270 as described with reference to FIG. 2) prior to the data being written to the one or more memory devices 330. By ordering (e.g., reordering) commands as described herein, the commands may be processed more efficiently, which may improve the overall performance of the memory system 310.

FIG. 4 illustrates a block diagram 400 of a memory system 420 that supports ordering entries of an input command queue in accordance with examples as disclosed herein. The memory system 420 may be an example of aspects of a memory system as described with reference to FIGS. 1 through 3. The memory system 420, or various components thereof, may be an example of means for performing various aspects of ordering entries of an input command queue as described herein. For example, the memory system 420 may include a reception component 425, a determination component 430, an ordering component 435, a writing component 440, a pointer component 445, or any combination thereof. Each of these components may communicate, directly or indirectly, with one another (e.g., via one or more buses).

The reception component 425 may be configured as or otherwise support a means for receiving, at an input command queue of a memory system, a first command including a first range of logical block addresses, a second command including a second range of logical block addresses, and a third command including a third range of logical block addresses, where the first command is received prior to the second command and the second command is received prior to the third command. The determination component 430 may be configured as or otherwise support a means for determining that a first logical block address of the third range of logical block addresses is contiguous with a last logical block address of the first range of logical block addresses based at least in part on receiving the first command, the second command, and the third command. The ordering component 435 may be configured as or otherwise support a means for ordering the first command, the second command, and the third command in the input command queue, where the third command is ordered in the input command queue directly following the first command based at least in part on determining that the first logical block address of the third range of logical block addresses is contiguous with the last logical block address of the first range of logical block addresses.

In some examples, the determination component 430 may be configured as or otherwise support a means for determining that a last logical block address of the first range of logical block addresses is non-contiguous with a first logical block address of the second range of logical block addresses based at least in part on receiving the first command, the second command, and the third command.

In some examples, the reception component 425 may be configured as or otherwise support a means for receiving, at the input command queue, a fourth command including a fourth range of logical block addresses prior to receiving the first command, the second command, and the third command. In some examples, the determination component 430 may be configured as or otherwise support a means for determining that one or more operations associated with the fourth command are being performed based at least in part on receiving the first command, the second command, and the third command where determining that the first logical block address of the third range of logical block addresses is contiguous with the last logical block address of the first range of logical block addresses is based at least in part on determining that the one or more operations associated with the fourth command are being performed.

In some examples, to support determining that the one or more operations associated with the fourth command are being performed, the pointer component 445 may be configured as or otherwise support a means for identifying a location of a pointer associated with the input command queue.

In some examples, the reception component 425 may be configured as or otherwise support a means for receiving, at the input command queue, a fifth command including a fifth range of logical block addresses and a sixth command including a sixth range of logical block addresses, where the fifth command is received prior to the fourth command and the sixth command is received after the fourth command. In some examples, the ordering component 435 may be configured as or otherwise support a means for refraining from re-ordering the sixth command to directly follow the fifth command based at least in part on determining that the one or more operations associated with the fourth command are being performed.

In some examples, the first command, and the reception component 425 may be configured as or otherwise support a means for receiving, at the input command queue, a seventh command including a seventh range of logical block addresses based at least in part on receiving the first command, the second command, and the third command. In some examples, the first command, and the ordering component 435 may be configured as or otherwise support a means for refraining from re-ordering the seventh command in the input command queue based at least in part on determining that the seventh command includes a second type of command different than the first type of command.

In some examples, the writing component 440 may be configured as or otherwise support a means for writing, by the memory system, first data associated with the first command to a first range of physical block addresses, second data associated with the third command to a second range of physical block addresses, and third data associated with the second command to a third range of physical block addresses based at least in part on ordering the first command, the second command, and the third command in the input command queue, where the first range of physical block addresses, the second range of physical block addresses, and the third range of physical block addresses are contiguous physical block addresses.

In some examples, the reception component 425 may be configured as or otherwise support a means for receiving, at the input command queue, a plurality of commands that each include a respective range of logical block addresses, where each of the plurality of commands are received in a sequential order. In some examples, the determination component 430 may be configured as or otherwise support a means for determining that a first logical block address of a range of logical block addresses of one or more entries in the input command queue is contiguous with a last logical block address of a range of logical block addresses of a prior entry in the input command queue based at least in part on receiving the plurality of commands. In some examples, the ordering component 435 may be configured as or otherwise support a means for ordering each of the plurality of commands in the input command queue based at least in part on determining that the first logical block address of the range of logical block addresses of one or more entries in the input command queue is contiguous with the last logical block address of the range of logical block addresses of a previous entry in the input command queue.

In some examples, the reception component 425 may be configured as or otherwise support a means for receiving, at an input command queue of a memory system, an eighth command including an eighth range of logical block addresses and a ninth command including a ninth range of logical block addresses, where the eighth command is received prior to the ninth command. In some examples, the determination component 430 may be configured as or otherwise support a means for determining that a last logical block address of the ninth range of logical block addresses is contiguous with a first logical block address of the eighth range of logical block addresses based at least in part on receiving the eighth command and the ninth command. In some examples, the ordering component 435 may be configured as or otherwise support a means for ordering the eighth command and the ninth command in the input command queue, where the eighth command is ordered in the input command queue directly following the ninth command based at least in part on determining that the last logical block address of the ninth range of logical block addresses is contiguous with the first logical block address of the eighth range of logical block addresses.

In some examples, the memory system includes a processor for processing commands in the input command queue. In some examples, the processor maintains a table of a mapping between logical addresses and physical addresses.

In some examples, when ordered in the input command queue, entries associated with each of the first command, the second command, and the third command indicate a location in a buffer of the memory system that associated data is located.

FIG. 5 illustrates a flowchart showing a method 500 that supports ordering entries of an input command queue in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at an input command queue of a memory system, a first command including a first range of logical block addresses, a second command including a second range of logical block addresses, and a third command including a third range of logical block addresses, where the first command is received prior to the second command and the second command is received prior to the third command. The operations of 505 may be performed in accordance with examples as disclosed herein. In some examples, aspects of the operations of 505 may be performed by a reception component 425 as described with reference to FIG. 4.

At 510, the method may include determining that a first logical block address of the third range of logical block addresses is contiguous with a last logical block address of the first range of logical block addresses based at least in part on receiving the first command, the second command, and the third command. The operations of 510 may be performed in accordance with examples as disclosed herein. In some examples, aspects of the operations of 510 may be performed by a determination component 430 as described with reference to FIG. 4.

At 515, the method may include ordering the first command, the second command, and the third command in the input command queue, where the third command is ordered in the input command queue directly following the first command based at least in part on determining that the first logical block address of the third range of logical block addresses is contiguous with the last logical block address of the first range of logical block addresses. The operations of 515 may be performed in accordance with examples as disclosed herein. In some examples, aspects of the operations of 515 may be performed by an ordering component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at an input command queue of a memory system, a first command including a first range of logical block addresses, a second command including a second range of logical block addresses, and a third command including a third range of logical block addresses, where the first command is received prior to the second command and the second command is received prior to the third command; determining that a first logical block address of the third range of logical block addresses is contiguous with a last logical block address of the first range of logical block addresses based at least in part on receiving the first command, the second command, and the third command; and ordering the first command, the second command, and the third command in the input command queue, where the third command is ordered in the input command queue directly following the first command based at least in part on determining that the first logical block address of the third range of logical block addresses is contiguous with the last logical block address of the first range of logical block addresses.

Aspect 2: The method, apparatus, or non-transitory computer-readable medium of aspect 1, further including operations, features, circuitry, logic, means, or instructions, or any combination thereof for determining that a last logical block address of the first range of logical block addresses is non-contiguous with a first logical block address of the second range of logical block addresses based at least in part on receiving the first command, the second command, and the third command.

Aspect 3: The method, apparatus, or non-transitory computer-readable medium of any of aspects 1 through 2, further including operations, features, circuitry, logic, means, or instructions, or any combination thereof for receiving, at the input command queue, a fourth command including a fourth range of logical block addresses prior to receiving the first command, the second command, and the third command and determining that one or more operations associated with the fourth command are being performed based at least in part on receiving the first command, the second command, and the third command where determining that the first logical block address of the third range of logical block addresses is contiguous with the last logical block address of the first range of logical block addresses is based at least in part on determining that the one or more operations associated with the fourth command are being performed.

Aspect 4: The method, apparatus, or non-transitory computer-readable medium of aspect 3, where determining that the one or more operations associated with the fourth command are being performed includes operations, features, circuitry, logic, means, or instructions, or any combination thereof for identifying a location of a pointer associated with the input command queue.

Aspect 5: The method, apparatus, or non-transitory computer-readable medium of any of aspects 3 through 4, further including operations, features, circuitry, logic, means, or instructions, or any combination thereof for receiving, at the input command queue, a fifth command including a fifth range of logical block addresses and a sixth command including a sixth range of logical block addresses, where the fifth command is received prior to the fourth command and the sixth command is received after the fourth command and refraining from re-ordering the sixth command to directly follow the fifth command based at least in part on determining that the one or more operations associated with the fourth command are being performed.

Aspect 6: The method, apparatus, or non-transitory computer-readable medium of any of aspects 1 through 5, where the first command and the method, apparatuses, and non-transitory computer-readable medium further includes operations, features, circuitry, logic, means, or instructions, or any combination thereof for receiving, at the input command queue, a seventh command including a seventh range of logical block addresses based at least in part on receiving the first command, the second command, and the third command and refraining from re-ordering the seventh command in the input command queue based at least in part on determining that the seventh command includes a second type of command different than the first type of command.

Aspect 7: The method, apparatus, or non-transitory computer-readable medium of any of aspects 1 through 6, further including operations, features, circuitry, logic, means, or instructions, or any combination thereof for writing, by the memory system, first data associated with the first command to a first range of physical block addresses, second data associated with the third command to a second range of physical block addresses, and third data associated with the second command to a third range of physical block addresses based at least in part on ordering the first command, the second command, and the third command in the input command queue, where the first range of physical block addresses, the second range of physical block addresses, and the third range of physical block addresses are contiguous physical block addresses.

Aspect 8: The method, apparatus, or non-transitory computer-readable medium of any of aspects 1 through 7, further including operations, features, circuitry, logic, means, or instructions, or any combination thereof for receiving, at the input command queue, a plurality of commands that each include a respective range of logical block addresses, where each of the plurality of commands are received in a sequential order; determining that a first logical block address of a range of logical block addresses of one or more entries in the input command queue is contiguous with a last logical block address of a range of logical block addresses of a prior entry in the input command queue based at least in part on receiving the plurality of commands; and ordering each of the plurality of commands in the input command queue based at least in part on determining that the first logical block address of the range of logical block addresses of one or more entries in the input command queue is contiguous with the last logical block address of the range of logical block addresses of a previous entry in the input command queue.

Aspect 9: The method, apparatus, or non-transitory computer-readable medium of any of aspects 1 through 8, further including operations, features, circuitry, logic, means, or instructions, or any combination thereof for receiving, at an input command queue of a memory system, an eighth command including an eighth range of logical block addresses and a ninth command including a ninth range of logical block addresses, where the eighth command is received prior to the ninth command; determining that a last logical block address of the ninth range of logical block addresses is contiguous with a first logical block address of the eighth range of logical block addresses based at least in part on receiving the eighth command and the ninth command; and ordering the eighth command and the ninth command in the input command queue, where the eighth command is ordered in the input command queue directly following the ninth command based at least in part on determining that the last logical block address of the ninth range of logical block addresses is contiguous with the first logical block address of the eighth range of logical block addresses.

Aspect 10: The method, apparatus, or non-transitory computer-readable medium of any of aspects 1 through 9, where the memory system includes a processor for processing commands in the input command queue and the processor maintains a table of a mapping between logical addresses and physical addresses.

Aspect 11: The method, apparatus, or non-transitory computer-readable medium of any of aspects 1 through 10, where when ordered in the input command queue, entries associated with each of the first command, the second command, and the third command indicate a location in a buffer of the memory system that associated data is located.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory system comprising an input command queue; and
a controller associated with the memory system, wherein the controller is configured to cause the apparatus to:
receive a first command comprising a first range of logical block addresses, a second command comprising a second range of logical block addresses, and a third command comprising a third range of logical block addresses, wherein the first command is received prior to the second command and the second command is received prior to the third command;
determine that a first logical block address of the third range of logical block addresses is contiguous with a last logical block address of the first range of logical block addresses based at least in part on receiving the first command, the second command, and the third command; and
order the first command, the second command, and the third command in the input command queue, wherein the third command is ordered in the input command queue directly following the first command based at least in part on determining that the first logical block address of the third range of logical block addresses is contiguous with the last logical block address of the first range of logical block addresses.

2. The apparatus of claim 1, wherein the controller is further configured to cause the apparatus to:
determine that a last logical block address of the first range of logical block addresses is non-contiguous with a first logical block address of the second range of logical block addresses based at least in part on receiving the first command, the second command, and the third command.

3. The apparatus of claim 1, wherein the controller is further configured to cause the apparatus to:
receive a fourth command comprising a fourth range of logical block addresses prior to receiving the first command, the second command, and the third command; and
receive an indication that one or more operations associated with the fourth command are being performed based at least in part on receiving the first command, the second command, and the third command wherein determining that the first logical block address of the third range of logical block addresses is contiguous with the last logical block address of the first range of logical block addresses is based at least in part on determining that the one or more operations associated with the fourth command are being performed.

4. The apparatus of claim 3, wherein to determine that the one or more operations associated with the fourth command are being performed, the controller is configured to cause the apparatus to:
receive an indication of a location of a pointer associated with the input command queue.

5. The apparatus of claim 3, wherein the controller is further configured to cause the apparatus to:
receive a fifth command comprising a fifth range of logical block addresses and a sixth command comprising a sixth range of logical block addresses, wherein the fifth command is received prior to the fourth command and the sixth command is received after the fourth command; and
refrain from re-ordering the sixth command to directly follow the fifth command based at least in part on determining that the one or more operations associated with the fourth command are being performed.

6. The apparatus of claim 1, wherein the first command, the second command, and the third command each comprise a first type of command, and the controller is further configured to cause the apparatus to:
receive a seventh command comprising a seventh range of logical block addresses based at least in part on receiving the first command, the second command, and the third command; and
refrain from re-ordering the seventh command in the input command queue based at least in part on determining that the seventh command comprises a second type of command different than the first type of command.

7. The apparatus of claim 1, further comprising:
a memory system controller associated with the memory system, wherein the memory system controller is configured to cause the apparatus to:
write first data associated with the first command to a first range of physical block addresses, second data associated with the third command to a second range of physical block addresses, and third data associated with the second command to a third range of physical block addresses based at least in part on ordering the first command, the second command, and the third command in the input command queue, wherein the first range of physical block addresses, the second range of physical block addresses, and the third range of physical block addresses are contiguous physical block addresses.

8. The apparatus of claim 1, wherein the controller is further configured to cause the apparatus to:
receive a plurality of commands that each comprise a respective range of logical block addresses, wherein each of the plurality of commands are received in a sequential order;
determine that a first logical block address of a range of logical block addresses of one or more entries in the input command queue is contiguous with a last logical block address of a range of logical block addresses of a prior entry in the input command queue based at least in part on receiving the plurality of commands; and
order each of the plurality of commands in the input command queue based at least in part on determining that the first logical block address of the range of logical block addresses of one or more entries in the input command queue is contiguous with the last logical block address of the range of logical block addresses of a previous entry in the input command queue.

9. The apparatus of claim 1, wherein the controller is further configured to cause the apparatus to:
receive an eighth command comprising an eighth range of logical block addresses and a ninth command comprising a ninth range of logical block addresses, wherein the eighth command is received prior to the ninth command;
determine that a last logical block address of the ninth range of logical block addresses is contiguous with a first logical block address of the eighth range of logical block addresses based at least in part on receiving the eighth command and the ninth command; and
order the eighth command and the ninth command in the input command queue, wherein the eighth command is ordered in the input command queue directly following the ninth command based at least in part on determining that the last logical block address of the ninth range of logical block addresses is contiguous with the first logical block address of the eighth range of logical block addresses.

10. The apparatus of claim 1, further comprising:
a memory system controller comprising a processor for processing commands in the input command queue, wherein the memory system controller maintains a table of a mapping between logical addresses and physical addresses.

11. The apparatus of claim 1, wherein when ordered in the input command queue, entries associated with each of the first command, the second command, and the third command indicate a location in a buffer of the memory system that associated data is located.

12. A non-transitory computer-readable medium storing code comprising instructions which, when executed by a processor of an electronic device, cause the electronic device to:
receive, at an input command queue of a memory system, a first command comprising a first range of logical block addresses, a second command comprising a second range of logical block addresses, and a third command comprising a third range of logical block addresses, wherein the first command is received prior to the second command and the second command is received prior to the third command;
determine that a first logical block address of the third range of logical block addresses is contiguous with a last logical block address of the first range of logical block addresses based at least in part on receiving the first command, the second command, and the third command; and
order the first command, the second command, and the third command in the input command queue, wherein the third command is ordered in the input command queue directly following the first command based at least in part on determining that the first logical block address of the third range of logical block addresses is contiguous with the last logical block address of the first range of logical block addresses.

13. The non-transitory computer-readable medium of claim 12, wherein the instructions, when executed by the processor of the electronic device, further cause the electronic device to:
determine that a last logical block address of the first range of logical block addresses is non-contiguous with a first logical block address of the second range of logical block addresses based at least in part on receiving the first command, the second command, and the third command.

14. The non-transitory computer-readable medium of claim 12, wherein the instructions, when executed by the processor of the electronic device, further cause the electronic device to:
receive, at the input command queue, a fourth command comprising a fourth range of logical block addresses prior to receiving the first command, the second command, and the third command; and
determine that one or more operations associated with the fourth command are being performed based at least in part on receiving the first command, the second command, and the third command wherein determining that the first logical block address of the third range of logical block addresses is contiguous with the last logical block address of the first range of logical block addresses is based at least in part on determining that the one or more operations associated with the fourth command are being performed.

15. The non-transitory computer-readable medium of claim 14, wherein to determine that the one or more operations associated with the fourth command are being performed, the instructions, when executed by the processor of the electronic device, further cause the electronic device to are executable by the processor to:
identify a location of a pointer associated with the input command queue.

16. The non-transitory computer-readable medium of claim 14, wherein the instructions, when executed by the processor of the electronic device, further cause the electronic device to:
receive, at the input command queue, a fifth command comprising a fifth range of logical block addresses and a sixth command comprising a sixth range of logical block addresses, wherein the fifth command is received prior to the fourth command and the sixth command is received after the fourth command; and
refrain from re-ordering the sixth command to directly follow the fifth command based at least in part on determining that the one or more operations associated with the fourth command are being performed.

17. The non-transitory computer-readable medium of claim 12, wherein the first command, the second command, and the third command each comprise a first type of command, wherein the instructions, when executed by the processor of the electronic device, further cause the electronic device to:
receive, at the input command queue, a seventh command comprising a seventh range of logical block addresses based at least in part on receiving the first command, the second command, and the third command; and
refrain from re-ordering the seventh command in the input command queue based at least in part on determining that the seventh command comprises a second type of command different than the first type of command.

18. The non-transitory computer-readable medium of claim 12, wherein the instructions, when executed by the processor of the electronic device, further cause the electronic device to:
write, by the memory system, first data associated with the first command to a first range of physical block addresses, second data associated with the third command to a second range of physical block addresses, and third data associated with the second command to a third range of physical block addresses based at least in part on ordering the first command, the second command, and the third command in the input command queue, wherein the first range of physical block addresses, the second range of physical block addresses, and the third range of physical block addresses are contiguous physical block addresses.

19. The non-transitory computer-readable medium of claim 12, wherein the instructions, when executed by the processor of the electronic device, further cause the electronic device to:
receive, at the input command queue, a plurality of commands that each comprise a respective range of logical block addresses, wherein each of the plurality of commands are received in a sequential order;
determine that a first logical block address of a range of logical block addresses of one or more entries in the input command queue is contiguous with a last logical block address of a range of logical block addresses of a prior entry in the input command queue based at least in part on receiving the plurality of commands; and
order each of the plurality of commands in the input command queue based at least in part on determining that the first logical block address of the range of logical block addresses of one or more entries in the input command queue is contiguous with the last logical block address of the range of logical block addresses of a previous entry in the input command queue.

20. A method, comprising:
receiving, at an input command queue of a memory system, a first command comprising a first range of logical block addresses, a second command comprising a second range of logical block addresses, and a third command comprising a third range of logical block addresses, wherein the first command is received prior to the second command and the second command is received prior to the third command;
determining that a first logical block address of the third range of logical block addresses is contiguous with a last logical block address of the first range of logical block addresses based at least in part on receiving the first command, the second command, and the third command; and
ordering the first command, the second command, and the third command in the input command queue, wherein the third command is ordered in the input command queue directly following the first command based at least in part on determining that the first logical block address of the third range of logical block addresses is contiguous with the last logical block address of the first range of logical block addresses.
